(19) United States
(12) Patent Application Publication
(10) Pub. No.: US 2015/0041445 A1
(43) Pub. Date: Feb. 12, 2015

(54) Laser Cutting Machine Capable Of Producing Focal Points With The Same Size

(71) Applicant: Great Computer Corporation, New Taipei City (TW)

(72) Inventors: Liang SHIH, New Taipei City (TW); Yung-En CHU, New Taipei City (TW); Ming-Che SU, New Taipei City (TW)

(73) Assignee: Great Computer Corporation, New Taipei City (TW)

(21) Appl. No.: 13/964,554

(22) Filed: Aug. 12, 2013

(51) Int. Cl. B23K 26/38

(52) U.S. Cl. CPC B23K 26/38
USPC 219/121.67

(57) ABSTRACT

A laser cutting machine capable of producing focal points with the same size comprises a working platform, a pen housing, and a beam expander. The pen housing is movably provided on the working platform for receiving laser beams from a laser tube to cut an article provided on the working platform. The beam expander is provided in a laser beam output path between the laser tube and the pen housing, so that the laser beams are output after passing sequentially through the beam expander and the pen housing, wherein the beam expander is provided movably on the working platform, and the displacement of the beam expander is changed with the displacement of the pen housing, so as to produce focal points with the same size after the laser beams are output.

### BACKGROUND OF THE INVENTION

1. Field of Invention

The present invention relates to a laser cutting machine capable of producing focal points with the same size, and particularly, to a laser cutting machine using a movable beam expander that is able to adjust the size of laser beams according to the locations at which a pen housing is moved, so as to maintain the cutting quality of the laser cutting machine at any location on a working platform.

2. Related Art

Nowadays in the printing industry, laser engraving/cutting and ink-jet printing are main branches. The basic working principle of a conventional laser-processing machine is to guide and focus laser beams on surfaces of articles to be engraved. There are two ways to achieve the engraving or cutting. The materials of the articles are gasified by the sudden increase of temperature thereof when the focused laser beams are absorbed by the materials, so that the surfaces of the articles are sunken. Alternatively, the surfaces of articles are heated and melt by the focused laser beams with high energy, and at same time the melt materials on the surfaces of the articles are blown away by high pressure gas.

Currently, a high watt laser tube is usually provided inside the housing of a large laser cutting machine. However, due to the huge size of machine platform, the divergent angle of the laser beams would be influenced, and consequently the cutting quality could not be maintained under the same power and frequency. Besides, the machine platform tolerance makes the platform surface uneven, which renders the focal distance slightly altered from one location to another. Therefore, the cutting quality would also be influenced.

Accordingly, those skilled in the art in the printing industry have been working on the improvement of the laser cutting machines in order to maintain the cutting quality at any location on the surfaces of the laser cutting machines.

### SUMMARY OF THE INVENTION

A primary object of the present invention is to provide a laser cutting machine using a movable beam expander that is able to adjust the size of laser beams according to the locations at which a pen housing is moved, so as to maintain the cutting quality of the laser cutting machine at any location on a working platform.

In order to achieve above object, the present invention provides a laser cutting machine capable of producing focal points with the same size, which comprises a working platform, a pen housing, and a beam expander. The pen housing is movable on the working platform for receiving laser beams from a laser tube to cut an article provided on the working platform. The beam expander is provided in a laser beam output path between the laser tube and the pen housing, so that the laser beams are output after passing sequentially through the beam expander and the pen housing. The beam expander is provided movably on the working platform, and the displacement of the beam expander is changed with the displacement of the pen housing, so as to produce focal points with the same size after the laser beams are output.

In implementation, the pen housing and the beam expander are disposed on the same track or respectively on different working tracks.

The present invention will become more fully understood by reference to the following detailed description thereof when read in conjunction with the attached drawings.

### BRIEF DESCRIPTION OF THE DRAWINGS

FIG. 1 is a perspective view of an embodiment of the present invention.

FIG. 2 is a schematic view showing the framework of the embodiment of the present invention.

### DETAILED DESCRIPTION OF THE INVENTION

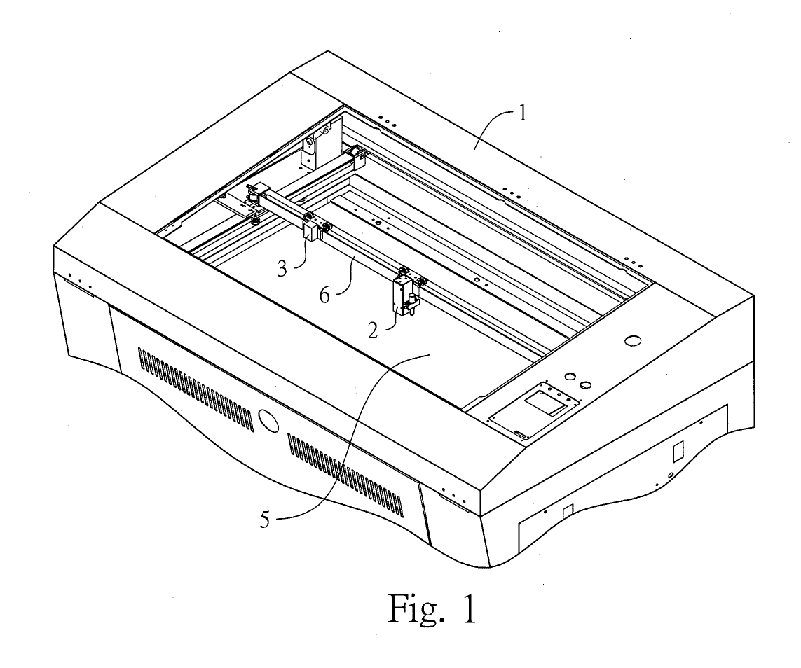

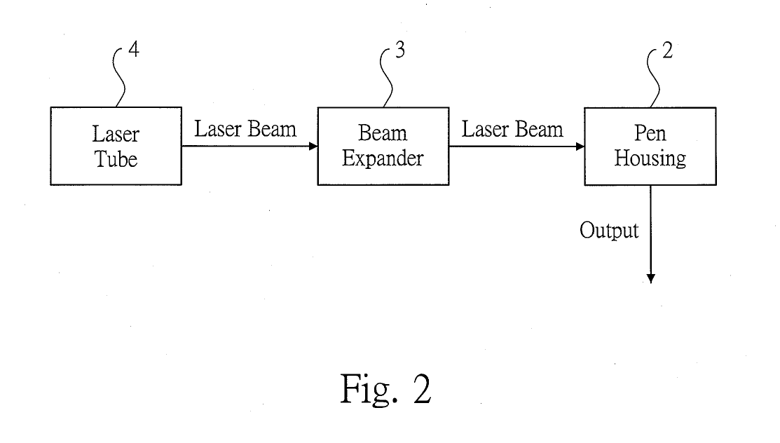

Please refer to FIGS. 1 and 2, where a framework of an embodiment of a laser cutting machine capable of producing focal points with the same size according to the present invention is illustrated. It comprises a working platform 1, a pen housing 2 and a beam expander 3.

The pen housing 2 is movably provided on the working platform 1 and is used for receiving laser beams from a laser tube 4 to cut an article 5 provided on the working platform 1. The beam expander 3 is provided in a laser beam output path between the laser tube 4 and the pen housing 2, so that the laser beams are output after passing sequentially through the beam expander 3 and the pen housing 2. The beam expander 3 is provided movably on the working platform 1, and the displacement of the beam expander 3 is changed with the displacement of the pen housing 2, so as to produce focal points with the same size after the laser beams are output.

Furthermore, the pen housing 2 and the beam expander 3 are disposed on the same track or respectively on different working tracks.

Therefore, in implementation, as shown in FIGS. 1 and 2, the beam expander 3 moves with the pen housing 2, and the moving distance of the beam expander 3 is adjusted with the coordinate of the moving pen housing 2. Moreover, the moving distance of the beam expander 3 also can be calculated and controlled through software and a computer processing unit, so as to produce focal points with the same size after the laser beams are output.

Accordingly, as disclosed in the above description of the present invention, the laser beam size is adjustable by moving the beam expander 3 with the pen housing 2 to different locations, so as to maintain the same cutting quality of the laser cutting machine at any location on the working platform.

Although the embodiments of the present invention have been described in details, many modifications and variations may be made by those skilled in the art from the teachings disclosed hereinabove. Therefore, it should be understood that any modification and variation equivalent to the spirit of the present invention be regarded to fall into the scope defined by the appended claims.

Accordingly, as disclosed above, the present invention can achieve the object of providing a laser cutting machine capable of producing focal points with the same size. It is novel and can be put into industrial use.

What is claimed is:

1. A laser cutting machine capable of producing focal points with the same size, comprising:
a working platform;
a pen housing, which is movable on the working platform for receiving laser beams from a laser tube to cut an article provided on the working platform; and
a beam expander, provided in a laser beam output path between the laser tube and the pen housing, so that the laser beams are output after passing sequentially through the beam expander and the pen housing, wherein the beam expander is provided movably on the working platform, and the displacement of the beam expander is changed with the displacement of the pen housing, so as to produce focal points with the same size after the laser beams are output.

2. The laser cutting machine capable of producing focal points with the same size as claimed in claim 1, wherein the pen housing and the beam expander are disposed on the same working track.

3. The laser cutting machine capable of producing focal points with the same size as claimed in claim 1, wherein the pen housing and the beam expander are respectively disposed on different working tracks.
